(19) United States
(12) Patent Application Publication
(10) Pub. No.: US 2016/0285096 A1
(43) Pub. Date: Sep. 29, 2016

(54) GRAPHITE MATERIAL AND ELECTRODE MATERIAL USING SAME

(71) Applicant: THE YOKOHAMA RUBBER CO., LTD., Tokyo (JP)

(72) Inventors: Tsukasa MARUYAMA, HIRATSUKA CITY, KANAGAWA (JP); Yoshimasa IMAZAKI, HIRATSUKA CITY, KANAGAWA (JP)

(21) Appl. No.: 15/031,384

(22) PCT Filed: Oct. 24, 2014
(86) PCT No.: PCT/JP2014/078343

§ 371 Date: Apr. 22, 2016

(30) Foreign Application Priority Data
Oct. 24, 2013 (JP) 2013-221349

(51) Int. Cl. H01M 4/587; H01M 10/0525; H01M 2/16; H01M 4/66; H01M 4/38; H01M 4/62; H01M 4/133

(52) U.S. Cl. CPC H01M 4/587; H01M 4/624; H01M 10/0525; H01M 4/623; H01M 4/625; H01M 4/133; H01M 4/661; H01M 4/382; H01M 2/1653; H01M 2/162; H01M 4/1393

(57) ABSTRACT

An object of the present invention is to provide an electrode material and a graphite material used for an electrode material, from which an electrochemical element with a small initial irreversible capacity and excellent cycle characteristics can be obtained. A graphite material of the present invention is a graphite material having a specific surface area of 0.1 to 30 m²/g, an intensity ratio R (I_{D}/I_{G}) of a peak intensity (I_{D}) at around 1,360 cm⁻¹ to a peak intensity (I_{G}) at around 1,580 cm⁻¹ of not less than 0.60 and not more than 1.30, and an intensity ratio S (I₁₅₂₀/I_{G}) of a peak intensity (I₁₅₂₀) at 1,520 cm⁻¹ to a peak intensity (I_{G}) at around 1,580 cm⁻¹ of not less than 0.55 and not more than 0.70, in a spectrum obtained by the laser Raman spectroscopy using an excitation wavelength of 532 nm.

### TECHNICAL FIELD

The present invention relates to a graphite material, and an electrode material and an electrochemical element using the graphite material.

### BACKGROUND ART

Lithium ion rechargeable batteries and electric double-layer capacitors are known as electrochemical elements.

Generally, in comparison to an electric double-layer capacitor, a lithium ion rechargeable battery has higher energy density and is capable of operation over a longer time interval.

On the other hand, in comparison to a lithium ion rechargeable battery, an electric double-layer capacitor is capable of rapid electrical charging and discharging, and working life over repeated uses is longer.

In recent years, a lithium ion capacitor has been developed as an electrochemical element that combines such respective advantages of a lithium ion rechargeable battery and an electric double-layer capacitor. Moreover, from the viewpoint of a lower cost, a sodium ion capacitor (sodium ion-type electrical storage device) has been developed.

For example, in the Patent Document 1, “a composite comprising a conductive polymer having nitrogen atoms and a porous carbon material, the conductive polymer being bonded to a surface of the porous carbon material, a total pore volume of all pores having a diameter of 0.5 to 100.0 nm being 0.3 to 3.0 cm³/g measured by Horvath-Kawazoe Method and BJH Method, a ratio of a pore volume of pores having a diameter not smaller than 2.0 nm and smaller than 20.0 nm measured by BJH Method to the total pore volume being 10 to 30%, and a ratio of a pore volume of pores having a diameter not smaller than 0.5 nm and smaller than 2.0 nm measured by Horvath-Kawazoe Method and BJH Method to the total pore volume being 70 to 90% (Claim 1)” is described, and an electrode material using the composite (Claim 5), and a lithium rechargeable battery using the electrode material as an anode (Claim 7) are described.

Patent Document 2 describes “a composite graphite particle for a non-aqueous rechargeable battery, the graphite particle being composited of a spherical graphite particle and a graphitized material of a graphitable binder, the composite graphite particle satisfying any of the conditions selected from the group consisting of:

(a) the composite graphite particle having the spherical graphite particle, at least a part of the spherical graphite particle being exposed, is included on a surface;

(b) the composite graphite particle having an incomplete laminate structure of the spherical graphite particle is included in the proximity of the surface;

(c) a ratio c=a/b is not less than 0.93, wherein the median diameter of the spherical graphite particles is a and the median diameter of the composite graphite particles is b;

(d) an Raman R value is not less than 0.10 and not more than 0.30, an average circularity is not less than 0.85, a tap density is not less than 0.87 g/cm³ and not more than 1.25 g/cm³, and a BET specific surface area is not less than 2.5 m²/g and not more than 8.0 m²/g;

(e) a volume of pore not smaller than 0.01 μm and not greater than 2 μm measured by a mercury porosimeter is not less than 0.05 mL/g and not more than 1 mL/g;

(f) an amount of CO groups present on the surface is not less than 1.15 μmol/m² and not more than 5 μmol/m², when normalized with the BET specific surface area;

(g) when a slurry is prepared using the composite graphite particles according to the condition described below in (i), coated using a doctor blade method on a rolled copper foil and dried, and pressed to an active material density of 1.70 g/cm³ to form an electrode, an average time required for an electrolyte solution to disappear completely on the electrode is not more than 180 seconds when a 5 μL droplet of the electrolyte solution having a composition of (ii) described below is added dropwise on the central portion of the electrode in the lengthwise direction from the height of 5 cm;

### (i) Condition for Slurry Preparation

20.00±0.02 g of the composite graphite particle, 20.00±0.02 g of an aqueous solution of 1 mass % carboxymethyl cellulose (CMC) and 0.25±0.02 g of an aqueous dispersion of styrene-butadiene rubber (SBR) are weighed and stirred manually, followed by stirring by a planetary rotating type mixer (a hybrid mixer) for 5 minutes and degassing for 30 seconds to prepare.

### (ii) Electrolyte Composition

To a mixed solvent of ethylene carbonate (EC), ethylmethyl carbonate (EMC), and dimethyl carbonate (DMC) (volume ratio=2:2:3), 1.0 M LiPF6 is included, then 2 vol % of vinylene carbonate is added.”

### CITATION LIST

### Patent Literature

Patent Document 1: Japanese Unexamined Patent Application Publication No. 2013-161835A

Patent Document 2: Japanese Unexamined Patent Application Publication No. 2008-181870A

### SUMMARY OF INVENTION

### Technical Problem

Upon studying the composite or the composite graphite particles described in Patent Document 1 and 2, the present inventors discovered that there is a room for improvement in a charge-discharge irreversible capacity during initial cycles of stabilizing treatment (“initial irreversible capacity” hereinafter) and in cycle characteristics depending on the type of porous carbon material and electrolyte composition.

Thus, an object of the present invention is to provide an electrode material and a graphite material used for an electrode material, from which an electrochemical element with a small initial irreversible capacity and excellent cycle characteristics can be obtained.

### Solution to Problem

As a result of diligent research to solve the problems above, the present inventors discovered that an electrochemical element with a small initial irreversible capacity and excellent cycle characteristics can be obtained by using a graphite material having a specific surface area in a certain range and certain numbers of peaks in a predetermined Raman spectrum, as an electrode material.

Specifically, the inventors discovered that the problems described above can be solved by the following features.
[1] A graphite material having a specific surface area of 0.1 to 30 m²/g,

an intensity ratio R (I_{D}/I_{G}) of a peak intensity (I_{D}) at around 1,360 cm⁻¹ to a peak intensity (I_{G}) at around 1,580 cm⁻¹ of not less than 0.60 and not more than 1.30, and an intensity ratio S (I₁₅₂₀/I_{G}) of a peak intensity (I₁₅₂₀) at around 1,520 cm⁻¹ to a peak intensity (I_{G}) at around 1,580 cm⁻¹ of not less than 0.55 and not more than 0.70, in a spectrum obtained by laser Raman spectroscopy using an excitation wavelength of 532 nm.

[2] The graphite material according to [1] above, comprising a composite of graphite and a conductive polymer.

[3] The graphite material according to [2] above, wherein the conductive polymer is a conductive polymer having a nitrogen atom and/or a conductive polymer having a sulfur atom.

[4] An electrode material comprising the graphite material described in any one of [1] to [3].

[5] An electrochemical element comprising the electrode material described in [4] above.

### Advantageous Effects of Invention

As described below, an electrode material and a graphite material used for an electrode material, from which an electrochemical element with a small initial irreversible capacity and excellent cycle characteristics can be obtained, can be provided, in accordance with the present invention.

### DESCRIPTION OF EMBODIMENTS

### [Graphite Material]

A graphite material of the present invention is a material having a specific surface area of 0.1 to 30 m²/g, an intensity ratio R (I_{D}/I_{G}) of a peak intensity (I_{D}) at around 1,360 cm⁻¹ to a peak intensity (I_{G}) at around 1,580 cm⁻¹ of not less than 0.60 and not more than 1.30, and an intensity ratio S (I₁₅₂₀/I_{G}) of a peak intensity (I₁₅₂₀) at 1,520 cm⁻¹ to a peak intensity (I_{G}) at around 1,580 cm⁻¹ of not less than 0.55 and not more than 0.70, in a spectrum obtained by laser Raman spectroscopy using an excitation wavelength of 532 nm (simply “Raman spectrum” hereinafter).

Here, “specific surface area” refers to a measurement value measured by a nitrogen adsorption BET method in accordance with the method specified in JIS K1477:2007.

“Raman spectrum” refers to a spectrum that indicates a wavelength and an intensity of a scattered light in Raman effect, and, in the present invention, it refers to a spectrum measured by a micro laser Raman spectrometer, Holo Lab 5000R (manufactured by Kaiser Optical System Inc.) using an excitation wavelength of 532 nm.

“A peak intensity (I_{D}) at around 1,360 cm⁻¹” refers to a peak intensity of the D band that appears at around 1,360 cm⁻¹, “a peak intensity (I_{G}) at around 1,580 cm⁻¹” refers to a peak intensity of the G band that appears at around 1,580 cm⁻¹, and “a peak intensity (I₁₅₂₀) at 1,520 cm⁻¹” refers to a peak intensity originating from organic materials other than graphite, that appears at 1,520 cm⁻¹.

By using such a graphite material as an electrode material, an electrochemical element having a small initial irreversible capacity and excellent cycle characteristics can be obtained.

The details are not entirely clear, however, the following reasons are conceivable.

First, the range (0.1 to 30 m²/g) of the specific surface area of the graphite material of the present invention is similar to the specific surface area of a typical graphite.

Then, the specification of Raman spectrum of the graphite material of the present invention (intensity ratio R=0.60 to 1.30, intensity ratio S=0.55 to 0.70) means that there is at least one peak other than the peaks due to carbon SP² bonds of the graphite, which appear at around 1,360 cm⁻¹ and 1,580 cm⁻¹, therefore the specification indicates that the graphite material of the present invention does not constitute solely of graphite.

These indicate that, though the graphite material of the present invention has a similar surface properties to that of a graphite, surprisingly, selective presence of an organic material (e.g. conductive polymer described below) at the end section (the end surface) of the laminar structure of the graphite is considered to suppress decomposition of the solvent at the graphite surface, improving the adsorption (taking-in) of the supporting electrolyte present in the electrolyte.

The specific surface area of the graphite material of the present invention is preferably 0.25 to 25 m²/g, and more preferably 0.5 to 20 m²/g, from the viewpoint of adsorption/desorption of supporting electrolyte.

Also, the graphite material of the present invention preferably comprises graphite and a conductive polymer described below, because the electrode material can be obtained, which may provide an excellent electrochemical element having a small initial irreversible capacity and excellent cycle characteristics.

The expression “composite” generally means a material resulting from compositing and integration, i.e. by combining two or more materials. However, for the present invention, the conductive polymer is in a state where at least part of the conductive polymer is adsorbed to an edge section or a space between the layers of the graphite.

### Conductive Polymer

No particular limitation is placed on the conductive polymer configuring the composite described above as long as the conductive polymer displays electrical conductivity (e.g. the electrical conductivity of not less than 10⁻⁹ Scm⁻¹) by introduction of a dopant. The polymer may be doped by a dopant or may be a polymer obtained by dedoping of such a polymer, as exemplified by a conductive polymer having a nitrogen atom (referred to as “nitrogen-containing conductive polymer”, hereinafter), a conductive polymer having a sulfur atom (referred to as “sulfur-containing conductive polymer”, hereinafter), a polyfluorene derivative and the like.

Among these, the nitrogen-containing conductive polymer and the sulfur-containing conductive polymer described below are preferable from the viewpoint of electrochemical stability and availability.

Specific examples of such nitrogen-containing conductive polymers include polyaniline, polypyrrole, polypyridine, polyquinoline, polythiazole, polyquinoxaline, and derivatives thereof. One of these may be used alone, or two or more may be used in combination.

Specific examples of such sulfur-containing conductive polymers include polythiophene, polycyclopentadithiophene, and derivatives thereof. One of these may be used alone, or two or more may be used in combination.

Among such conductive polymers, the nitrogen-containing conductive polymers are preferred, and polyaniline, polypyridine, and derivatives thereof are more preferred due to the low cost of the raw materials and ease of synthesis.

The average molecular weight of such a conductive polymer is preferably 1,000 to 2,000,000, more preferably 3,000 to 1,500,000 and even more preferably 5,000 to 1,000,000, because it will not block the space between layers of the graphite and result in the stable charge and discharge properties.

The average molecular weight is a value measured by Gel Permeation Chromatography (GPC) and normalized using polystyrene of a known molecular weight, or a value measured by a light scattering method (static light scattering method).

It should be noted that the method of preparation of the conductive polymer is not particularly limited.

A dispersion of the conductive polymer can be produced by chemical polymerization (e.g. oxidative polymerization, dehalogenation polymerization and the like) of corresponding monomers (e.g. aniline, pyridine and the like) in a non-polar solvent or an aprotic solvent.

For any of the dopants or the additives for chemical polymerization (e.g. oxidizing agents, molecular weight adjustment agents, phase transfer catalysts, or the like) described above, those described in Japanese Patent No. 4294067B may be used as appropriate.

Also, commercially available products can be used for the conductive polymer.

Specific examples of the commercially available products include: organic solvent dispersion of polyaniline manufactured by Nissan Chemical Industries, Ltd. (trade name: ORMECON), aqueous dispersion of polyaniline manufactured by Nissan Chemical Industries, Ltd., dispersion of polyaniline manufactured by Kaken Sangyo K.K (toluene dispersion, aqueous dispersion), dispersion of polyanilinexylene manufactured by Sigma-Aldrich Co. LLC., dispersion of polythiophene manufactured by Shin-Etsu Polymer Co., Ltd. (trade name: SEPLEGYDA), dispersion of polythiophene manufactured by Sigma-Aldrich Co. LLC. (Product No. 483095, 739324, 739332 and the like), dispersion of polypyrrole manufactured by Japan Carlit Co., Ltd. and the like.

### Graphite

The graphite forming the composite described above preferably has a specific surface area of 0.1 to 30 m²/g.

No particular limitation is placed on the graphite, and any known graphite may be utilized that is used as the lithium ion rechargeable battery anode active material or the like. Specific examples of such graphite include natural graphite, artificial graphite, hardly graphitizable carbon, easily graphitizable carbon, graphitized meso-carbon micro beads, graphitized mesophase pitch carbon fibers, or the like. One of these may be used alone, or two or more may be used in combination.

### Production Method of Graphite Material

The production method of the graphite material of the present invention is not particularly limited. For example, the production method of the composite comprising the conductive polymer and the graphite includes various methods described below.

### Preparation Method of Composite (Part 1)

The conductive polymer and the graphite can be composited as follows: the dispersion solution (“graphite dispersion”, hereinafter) is prepared by dispersing graphite in a solvent (e.g. a non-polar solvent such as toluene) and heated up to the temperature of about 90 to 130° C. to reduce the solvent viscosity; the dispersion solution (“the conductive polymer dispersion”, hereinafter), in which the conductive polymer was dispersed in advance, is added to the graphite dispersion and blended; subsequently, the dopants may be removed by dedoping as necessary.

Exemplary methods for dedoping include: a method of dedoping the doped conductive polymer, and performing base treatment capable of neutralizing the dopant; a method of heat treatment of the dopant at a temperature that does not destroy the conductive polymer; or the like. Specifically, the methods described in Japanese Patent No. 5041058B and Japanese Patent No. 5110147B may be employed.

### Preparation Method of Composite (Part 2)

The conductive polymer and the graphite can be composited as follows: the graphite dispersion and the conductive polymer dispersion, described in the Preparation Method (Part 1) are prepared separately, and the conductive polymer dispersion and the graphite dispersion treated by a high-pressure homogenizer in advance are blended by a high-pressure homogenizer; subsequently, the dopants may be removed by dedoping as necessary.

### Preparation Method of Composite (Part 3)

The conductive polymer and the graphite can be composited as follows: the dispersion solution, in which the graphite is dispersed in a solvent (e.g. a polar solvent such as methanol), and the dispersion solution, in which the conductive polymer was dispersed in a solvent (e.g. non-polar solvent such as toluene), are blended; subsequently, the dopants may be removed by dedoping as necessary.

In the present invention, the composite comprising the conductive polymer and the graphite described above preferably contains not less than 0.01 parts by mass and less than 0.5 parts by mass, more preferably 0.02 to 0.49 parts by mass and even more preferably 0.05 to 0.45 parts by mass of the conductive polymer, based on 100 parts by mass of the graphite.

### Electrode Material and Electrochemical Element

The electrode material of the present invention is an electrode material that utilizes the graphite material of the present invention as the active material. For example, the electrode material of the present invention may be used suitably as an electrode material of an electrochemical element (e.g. an electric double-layer capacitor, a lithium ion rechargeable battery, a lithium ion capacitor, a sodium ion capacitor and the like).

Specifically, the electrode material of the present invention may be used suitably as an anode of a lithium ion rechargeable battery, an anode of a lithium ion capacitor, and the like.

It should be noted that the electrochemical element of the present invention may adopt a conventional known structure, and may be produced by the conventionally known production methods, as well as used as an electrode material of the present invention described above.

### EXAMPLES

The present invention will now be described in detail using the following working examples, but is in no way limited to these examples.

### Preparation of Polyaniline Toluene Dispersion 1

8 g of aniline, 17.3 g of dodecyl benzenesulfonic acid, and 11.6 mg of 2,4,6-trimethylaniline (0.001 equivalent relative to the aniline) as a molecular weight adjustment agent (terminal sealing agent) were dissolved in 1,500 g of toluene. Thereafter, to this mixture was added 500 g of distilled water into which 15 mL of 6N hydrochloric acid was dissolved.

To the mixed solution, 2.4 g of tetrabutyl ammonium bromide was added, the mixture was cooled to 5° C. or less, then 450 g of distilled water, in which 23.5 g of ammonium persulfate was dissolved, was added.

The mixture was oxidatively polymerized in a state of 5° C. or less for 6 hours, then 500 g of toluene, and a methanol-water mixed solvent (water/methanol=2/3 (mass ratio)) were added thereto, and the resultant mixture was stirred.

After the end of stirring, the reaction solution was separated into the toluene layer and the aqueous layer, and only the aqueous layer was removed so as to obtain a polyaniline toluene dispersion 1.

Part of the polyaniline toluene dispersion 1 was sampled, and the toluene was removed by vacuum distillation to determine solids content of the dispersion as 1.2% by mass (polyaniline content=0.4% by mass, polyaniline number average molecular weight=7,800).

Moreover, there was no plugging when this dispersion was filtered through a 1.0 μm pore diameter filter. The polyaniline particle diameter in the dispersion was analyzed using an ultrasonic particle size distribution measurement apparatus (APS-100, manufactured by Matec Applied Sciences). The polyaniline particles were found to be monodispersed (peak value=0.19 μm, half width=0.10 μm).

Furthermore, this dispersion did not agglomerate or precipitate even after the elapse of 1 year at room temperature, and thus was stable. From the elementary analysis, the molar ratio of the dodecyl benzene sulfonic acid per aniline monomer unit was 0.45. The yield of the polyaniline obtained was 95%.

### Preparation of Graphite

The graphite was prepared in the same manner as described in Working Example 4 in Japanese Unexamined Patent Application Publication 2009-84099A.

The specific surface area of the prepared graphite was 4.3 m²/g. As for the spectrum obtained by laser Raman spectroscopy using an excitation wavelength of 532 nm, the intensity ratio R (I_{D}/I_{G}) of a peak intensity (I_{D}) at around 1,360 cm⁻¹ to a peak intensity (I_{G}) at around 1,580 cm⁻¹ was 1.05, and the intensity ratio S (I₁₅₂₀/I_{G}) of a peak intensity (I₁₅₂₀) at 1,520 cm⁻¹ to a peak intensity (I_{G}) at around 1,580 cm⁻¹was 0.53.

### Working Examples 1 to 4

First, the graphite-methanol dispersion, in which 100 g of the prepared graphite was dispersed in 1,000 g of methanol, was prepared.

Then, the polyaniline toluene dispersion 1 (polyaniline content: 0.4 mass %) prepared above was added to the graphite-methanol dispersion to make the blending quantity of the polyaniline to be the value listed in Table 1 below (the value in parenthesis), and the mixed dispersion thereof was prepared.

To the mixed dispersion, 30 mL of triethylamine was added, then the mixture was stirred and mixed for 5 hours.

After the end of the stirring, the precipitate was recovered by filtration and washed with methanol. The filtrate and the washed solution at this time were colorless and transparent.

The washed and purified precipitate was dried in vacuo to prepare the graphite material comprising polyaniline/graphite composite.

The values for the specific surface area, the intensity ratio R (I_{D}/I_{G}) and the intensity ratio S (I₁₅₂₀/I_{G}) for each prepared graphite sample are listed in Table 1 below.

### REFERENCE EXAMPLE

As a reference example, the prepared graphite was used as a graphite material.

### Comparative Example 1

### Preparation of the Graphite Material

### (Polyaniline/Graphite Composite)

100 g of the prepared graphite was added to 250 g of the polyaniline toluene dispersion 1 (polyaniline content: 1 g) to obtain a mixed dispersion.

To the mixed dispersion, 50 mL of a 2 mol/L triethylamine in methanol solution was added, then the mixture was stirred and mixed for 5 hours.

After the end of the stirring, the precipitate was recovered by filtration and washed with methanol. The filtrate and the washed solution at this time were colorless and transparent.

The washed and purified precipitate was dried in vacuo to prepare the graphite material comprising polyaniline/graphite composite.

The values for the specific surface area, the intensity ratio R (I_{D}/I_{G}) and the intensity ratio S (I₁₅₂₀/I_{G}) for the prepared graphite sample are listed in Table 1 below.

### Surface Properties and Other Properties

For each prepared graphite samples, specific surface area and Raman spectrum were measured by the methods described below. These results are listed below in Table 1.

### Specific Surface Area

In accordance with the test method specified in JIS K1477:2007, the specific surface area was measured using the BET method by nitrogen adsorption, utilizing a high-precision gas/vapor adsorption measurement equipment (BELSORP-max, manufactured by Nihon Bel Corp.).

### Raman Spectrum

Raman spectrum was measured by a micro laser Raman spectrometer, Holo Lab 5000R (manufactured by Kaiser Optical System Inc.) using an excitation wavelength of 532 nm.

### Production of Lithium Ion Rechargeable Battery Anode

Respective prepared graphite material, acetylene black, and binder (polyfluoroethylene resin) were blended and dispersed at the mass ratio of 85:10:5, and was formed into sheet shape by a pressure roll. A disk shape piece (diameter 1.6 cm) was cut out from the sheet obtained, and subjected to compression bonding with a copper foil to produce an anode (25 mg).

### Production of Test Cell

A three-electrode cell was prepared as follows. All the operations were conducted in a glove box, under the dry argon atmosphere.

In a cell equipped with a polypropylene screw cap (inner diameter ca. 18 mm), the anode described above and a metal lithium foil were laminated interposing a propylene separator between them. As a reference electrode, a metal lithium was further laminated. An electrolyte solution was added thereto to produce a test cell.

Using the test cell produced, the stabilizing treatment and charge-discharge test described below were conducted. The initial irreversible capacity and the result of the charge-discharge test (initial charge capacity, initial discharge capacity, maintenance factor for discharge capacity after 100 cycles) are listed in Table 1 below.

### Stabilizing Treatment

The cell was charged in CC-CV mode (constant current-constant voltage, the charging completes upon reaching the current value of 0.005 C) until the anode potential relative to the reference electrode reached 0.002 V from the open circuit potential at 0.1 C rate (the rate at which full charging is achieved in 10 hours). Subsequently, the cell was subjected to closed-circuit operation with discharging at CC mode (constant current) for seven cycles, until it reached 1.5 V at 0.1 C rate.

From the charge-discharge result of the first cycle during the stabilizing treatment, the ratio of the initial irreversible capacity was obtained according to the formula below.

(Ratio of initial irreversible capacity)=[1−((discharged capacity during the first cycle of the stabilizing treatment)/(charged capacity during the first cycle of the stabilizing treatment))]×100(%)

### Charge-Discharge Test

After the stabilizing treatment described above, the charge-discharge test was conducted under the condition below. The cell was charged in CC-CV charging (the charging completes upon reaching the current value of 0.05 C) until the anode potential relative to the reference electrode reached 0.002 V at 1.0 C rate (the rate at which full charging is achieved in 1 hour). Subsequently, the cell was subjected to the charge-discharge test in which discharging at CC mode until it reached 1.5 V at 1.0 C rate. It should be noted that the charged capacity and the discharge capacity during the first cycle after the charge-discharge test was started were defined as the initial charge capacity and the initial discharge capacity, respectively.

TABLE 1

| | | | | | | Comparative |
|---|---|---|---|---|---|---|
| | Reference | Working Example | | | | Examples |
| | Example | 1 | 2 | 3 | 4 | 1 |
| Graphite | 100 | 100 | 100 | 100 | 100 | 100 |
| Polyaniline toluene | — | 12.5 | 25 | 62.5 | 112.5 | 250 |
| dispersion 1 | | (0.05) | (0.1) | (0.25) | (0.45) | (1.0) |
| (Polyaniline content amount | | | | | | |
| 0.4 mass %) | | | | | | |
| Specific surface area | 4.3 | 4.3 | 4.3 | 4.3 | 4.2 | 2.1 |
| (m²/g) | | | | | | |
| Intensity Ratio R (I_{D}/I_{G}) | 1.05 | 1.05 | 1.05 | 1.04 | 1.04 | 1.02 |
| Intensity Ratio S (I₁₅₂₀/I_{G}) | 0.53 | 0.56 | 0.59 | 0.64 | 0.68 | 0.74 |
| Ratio of initial | 28 | 20 | 18 | 16 | 12 | 30 |
| irreversible capacity | | | | | | |
| during the stabilization | | | | | | |
| treatment (%) | | | | | | |
| Initial charge capacity | 240 | 243 | 248 | 252 | 254 | 230 |
| (mAh/g) | | | | | | |
| Initial discharge capacity | 234 | 239 | 243 | 248 | 251 | 218 |
| (mAh/g) | | | | | | |
| Maintenance factor for | 78 | 90 | 90 | 92 | 93 | 83 |
| discharge capacity after | | | | | | |
| 100 cycles | | | | | | |

From the results listed in Table 1, it was discovered that a cell having a Raman spectrum intensity ratio S (I₁₅₂₀/I_{G}) less than 0.55 exhibits inferior cycle characteristics even if it has a specific surface area in the specified range (Reference Example). Also, a cell having the intensity ratio (I₁₅₂₀/I_{G}) larger than 0.70 exhibits a larger initial irreversible capacity and inferior cycle characteristics (Comparative Example 1).

By contrast, it was also discovered that cells having a Raman spectrum intensity ratio R (I_{D}/I_{G}) in the range of 0.60 to 1.30, an intensity ratio S (I₁₅₂₀/I_{G}) in the range of 0.55 to 0.70 exhibit a small initial irreversible capacity and superior cycle characteristics (Working Examples 1 to 4).

1. A graphite material having a specific surface area of 0.1 to 30 m²/g, an intensity ratio R (I_{D}/I_{G}) of a peak intensity (I_{D}) at around 1,360 cm⁻¹ to a peak intensity (I_{G}) at around 1,580 cm⁻¹ of not less than 0.60 and not more than 1.30, and an intensity ratio S (I₁₅₂₀/I_{G}) of a peak intensity (O₁₅₂₀) at 1,520 cm⁻¹ to a peak intensity (I_{G}) at around 1,580 cm⁻¹ of not less than 0.55 and not more than 0.70, in a spectrum obtained by laser Raman spectroscopy using an excitation wavelength of 532 nm.

2. The graphite material according to claim 1, comprising a composite of graphite and a conductive polymer.

3. The graphite material according to claim 2, wherein the conductive polymer is a conductive polymer having a nitrogen atom and/or a conductive polymer having a sulfur atom.

4. An electrode material comprising the graphite material described in claim 1.

5. An electrochemical element comprising the electrode material described in claim 4.

6. An electrode material comprising the graphite material described in claim 2.

7. An electrode material comprising the graphite material described in claim 3.

8. An electrochemical element comprising the electrode material described in claim 6.

9. An electrochemical element comprising the electrode material described in claim 7.
